(19) United States
(12) Patent Application Publication
(10) Pub. No.: US 2024/0061361 A1
(43) Pub. Date: Feb. 22, 2024

(54) TONER CARTRIDGE, IMAGE FORMING APPARATUS

(71) Applicant: KYOCERA Document Solutions Inc., Osaka (JP)

(72) Inventor: Hiroaki KITAGAWA, Osaka-shi (JP)

(73) Assignee: KYOCERA Document Solutions Inc., Osaka (JP)

(21) Appl. No.: 18/451,493

(22) Filed: Aug. 17, 2023

(30) Foreign Application Priority Data
Aug. 19, 2022 (JP) 2022-131028

(51) Int. Cl. G03G 15/08

(52) U.S. Cl. CPC G03G 15/0889; G03G 15/087; G03G 2215/0132; G03G 2215/0827

(57) ABSTRACT

A toner cartridge includes a cartridge case, a stirring paddle and a stirring sheet. In the cartridge case, a toner stirring chamber is formed. The stirring paddle is rotatably installed in the stirring chamber. The stirring sheet is rotatable together with the stirring paddle in the stirring chamber. The cartridge case has a toner supply port. The stirring sheet protrudes outward in a radial direction from a rotational locus drawn by a tip end of the stirring paddle. When the stirring paddle is positioned at a specific rotational phase, the stirring sheet blocks the supply port.

### INCORPORATION BY REFERENCE

This application is based on and claims the benefit of priority from Japanese patent application No. 2022-131028 filed on Aug. 19, 2022, which is incorporated by reference in its entirety.

### BACKGROUND

The present disclosure relates to a toner cartridge and an image forming apparatus.

A toner cartridge detachably attached to a developing device is known. The toner cartridge includes a stirring paddle provided in a cartridge case, and the stirring paddle stirs a toner stored in the cartridge case. The cartridge case has a toner supply port through which the toner is supplied to the developing device when the toner cartridge is attached to the developing device. When such a cartridge case is shipped, in order to prevent leakage of the toner, the supply port is covered with a seal member.

### SUMMARY

A toner cartridge according to the present disclosure includes a cartridge case, a stirring paddle and a stirring sheet. In the cartridge case, a toner stirring chamber is formed. The stirring paddle is rotatably installed in the stirring chamber. The stirring sheet is rotatable together with the stirring paddle in the stirring chamber. The cartridge case has a toner supply port. The stirring sheet protrudes outward in a radial direction from a rotational locus drawn by a tip end of the stirring paddle. When the stirring paddle is positioned at a specific rotational phase, the stirring sheet blocks the supply port.

In accordance with one aspect of the present disclosure, an image forming apparatus includes the toner cartridge.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view showing an image forming apparatus according to the present embodiment.

FIG. 2 is a perspective view showing a developing cartridge according to the present embodiment.

FIG. 3 is a perspective view showing a stirring member according to the present embodiment.

FIG. 4 is a sectional view schematically showing the developing cartridge according to the present embodiment.

FIG. 5 is a transition diagram showing a stirring operation of the developing cartridge according to the present embodiment.

### DETAILED DESCRIPTION

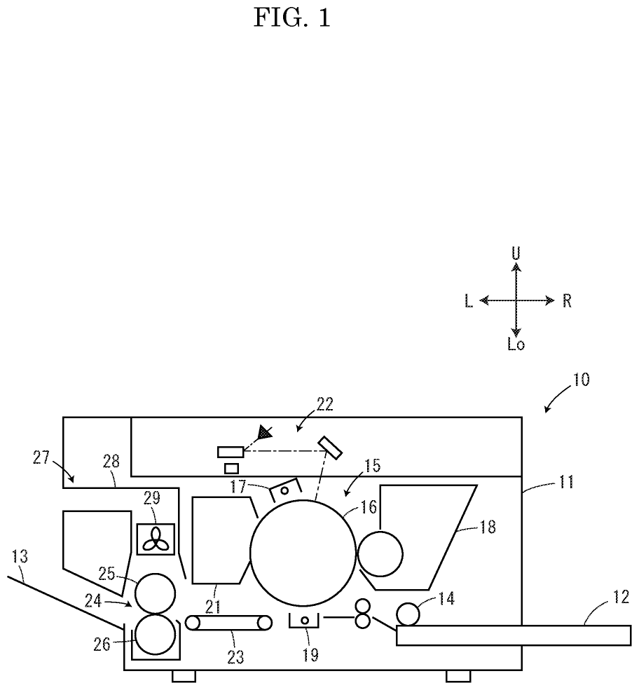

Hereinafter, with reference to the drawings, an image forming apparatus provided with a developing cartridge will be described. FIG. 1 is a schematic view showing the image forming apparatus according to the embodiment. In the following description, a printer will be described as an example of the image forming apparatus. Arrows L, R, U, Lo, FR and RE appropriately attached to each figure indicate the left side, the right side, the upper side, the lower side, the front side and the rear side when the image forming apparatus is viewed from the front side.

As shown in FIG. 1, the image forming apparatus 10 includes a box-shaped housing 11. On the right side surface of the housing 11, a sheet feeding cassette 12 in which a sheet bundle is set is installed, and on the left side surface of the housing 11, a sheet discharge tray 13 on which the image-formed sheets are stacked is provided. In the housing 11, a conveyance path along which the sheet is conveyed from the sheet feeding cassette 12 to the sheet discharge tray 13 is formed by a plurality of rollers or the others. Near the front end of the sheet feeding cassette 12, a pickup roller 14 is installed which picks up the sheet from the sheet bundle in the sheet feeding cassette 12 and feeds it to the upstream end of the conveyance path.

Downstream of the pickup roller 14, an image forming unit 15 which forms an image on the sheet is provided. The image forming unit 15 is provided with a photosensitive drum 16 which is rotatable in contact with the sheet. Around the photosensitive drum 16, a charging device 17, a developing cartridge (a toner cartridge) 18, a transferring device 19 and a cleaning device 21 are installed in the order of the transferring process. A waste toner box (not shown) is connected to the cleaning device 21. Above the image forming unit 15, an exposure device 22 is installed which emits laser light toward the photosensitive drum 16.

Downstream of the image forming unit 15, a conveyance belt 23 is installed, and downstream of the conveyance belt 23, a fixing device 24 which heat-fixes an unfixed toner image on the sheet is installed. The fixing device 24 includes a fixing belt 25 and a pressing roller 26 facing each other across the conveyance path. A heater (not shown) is built into the fixing belt 25. Above the fixing device 24, an exhaust device 27 is installed which discharges exhaust gas generated at the time of fixing outside the housing 11. The duct 28 of the exhaust device 27 includes a fan 29 which draws the exhaust gas generated near the fixing device 24 into the duct 28.

During an image forming operation of the image forming apparatus 10, after the surface of the photosensitive drum 16 is charged by the charging device 17, an electrostatic latent image is formed on the surface of the photosensitive drum 16 by the laser light from the exposure device 22. The toner is adhered from the developing cartridge 18 to the electrostatic latent image on the surface of the photosensitive drum 16 to form a toner image. On the other hand, the sheet is picked up from the sheet feeding cassette 12 by the pickup roller 14 and then conveyed toward the transferring device 19 in accordance with the image forming operation, and the toner image is transferred from the surface of the photosensitive drum 16 to the surface of the sheet by the transferring device 19. The waste toner remaining on the photosensitive drum 16 is removed by the cleaning device 21.

The toner-transferred sheet is transferred from the transferring device 19 to the conveyance belt 23 and then conveyed toward the fixing device 24 by the conveyance belt 23. In the fixing device 24, the unfixed toner image is melted by the heat of the fixing belt 25 and then fixed on the sheet by the pressure of the fixing belt 25 and the pressing roller 26. The toner-fixed sheet is fed to the sheet discharge tray 13 by the fixing belt 25 and the pressing roller 26. The exhaust gas is generated when the sheet is fixed, and the generated exhaust gas is drawn into the duct 28 by the fan 29 of the exhaust device 27 and then discharged out of the housing 11 through the duct 28.

Incidentally, a general developing cartridge includes a stirring member having a sheet member, and the toner in the cartridge is stirred by the rotation of the sheet member. In addition, a general developing cartridge may include a seal member to prevent toner leakage during transportation. In such a developing cartridge, the number of members is increased by the number corresponding to the seal member, and the work of attaching the seal member to the developing cartridge occurs. Therefore, in the developing cartridge 18 of the embodiment, a supply port of the cartridge is blocked from the inside by the stirring member to prevent the toner leakage during transportation.

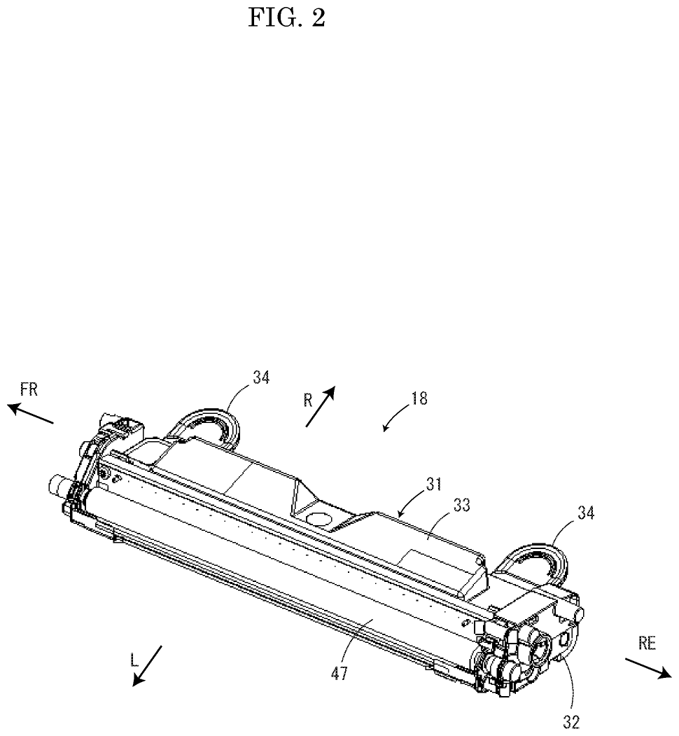

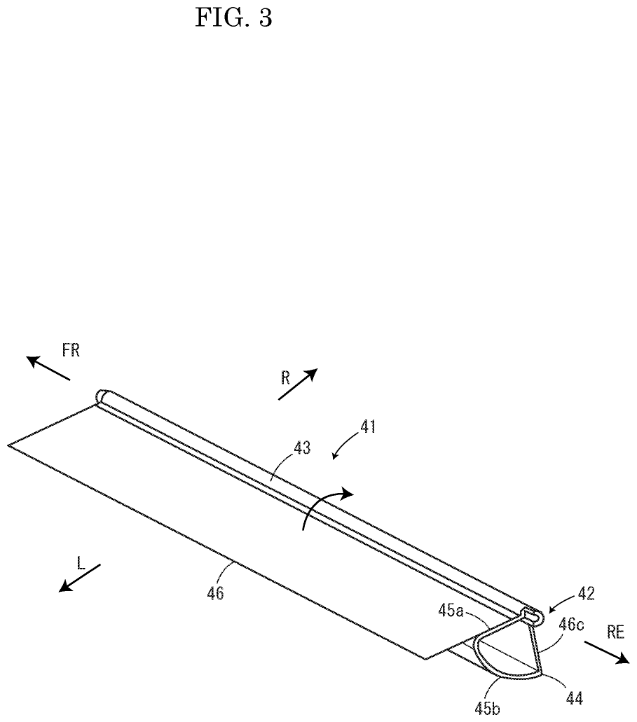

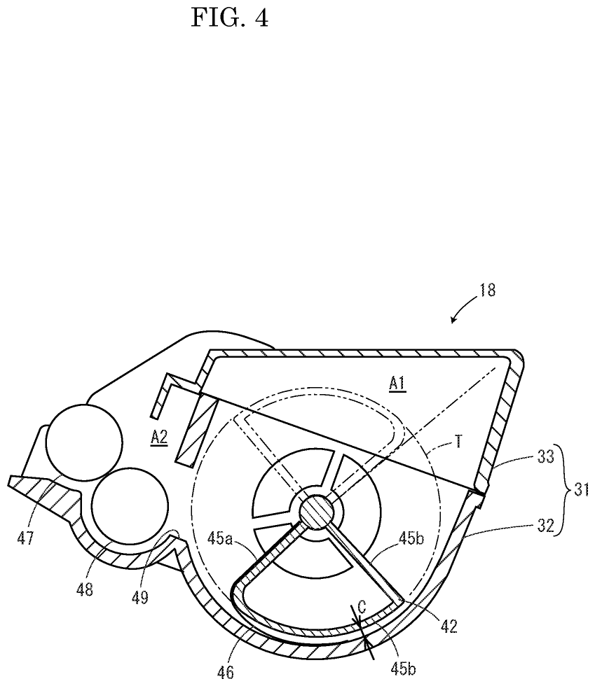

With reference to FIG. 2 to FIG. 4, the developing cartridge will be described. FIG. 2 is a perspective view showing the developing cartridge of the embodiment. FIG. 3 is a perspective view showing the stirring member of the embodiment. FIG. 4 is a schematic cross-sectional view showing the developing cartridge of the embodiment.

As shown in FIG. 2, the cartridge case 31 of the developing cartridge 18 extends in the front-and-rear direction along the photosensitive drum 16 (see FIG. 1). The cartridge case 31 includes a case cover 33 and a case body 32 attached to the case body 32, and the case body 32 and the case cover 33 form a toner stirring chamber A1 (see FIG. 4). A developing device such as a developing roller 47 is installed on the left side surface of the cartridge case 31, and a pair of tabs 34 for gripping the developing cartridge 18 is formed on the right side surface of the cartridge case 31. A stirring member 41 (see FIG. 3) is installed in the stirring chamber A1 of the cartridge case 31.

As shown in FIG. 3, the stirring member 41 includes a fan-shaped stirring paddle 42 in a cross section and a film-shaped stirring sheet 46. A rotational shaft 43 is provided at the center of rotation of the stirring paddle 42, and a hollow paddle part 44 extends outward in the radial direction from the rotational shaft 43. Although the stirring paddle 42 is resin-molded, by forming the stirring paddle 42 in a hollow cylindrical shape, rigidity of the stirring paddle 42 is enhanced to suppress a deformation of the stirring paddle 42 due to toner resistance. The stirring paddle 42 is rotatable in the direction of the arrow shown in the figure around the rotational shaft 43, and the stirring sheet 46 is attached to the front flat surface 45a in the rotational direction of the stirring paddle 42.

The stirring sheet 46 is formed into a rectangular shape, and made of a flexible sheet made of resin. The base end side of the stirring sheet 46 is attached to the stirring paddle 42, and the tip end side of the stirring sheet 46 protrudes outward in the radial direction from the stirring paddle 42. The tip end side of the stirring sheet 46 is formed so as to be deformable along the outer circumferential surface of the stirring paddle 42. At this time, the angle between the front flat surface 45a in the rotational direction of the stirring paddle 42 and the arc surface 45b is curved so that the stirring sheet 46 is not bent and deformed. On the other hand, since there is no stirring sheet 46 on the rear side in the rotational direction of the stirring paddle 42, the angle between the rear flat surface 45c in the rotation direction of the stirring paddle 42 and the arc surface 45b is bent.

As shown in FIG. 4, the toner stirring chamber A1 is formed in the cartridge case 31, and the stirring paddle 42 is rotatably installed in the stirring chamber A1. To install the stirring paddle 42 in the stirring chamber A1, a clearance C is required between the inner circumferential surface of the cartridge case 31 and the arc surface 45b of the stirring paddle 42. For this reason, the stirring sheet 46 is attached to the front flat surface 45a in the rotational direction of the stirring paddle 42. The stirring sheet 46 protrudes outward in the radial direction from the rotational locus T drawn by the arc surface 45b (the tip) of the stirring paddle 42, and the tip end side of the stirring sheet 46 is deformed so as to be able to enter the clearance C.

By rotating the stirring sheet 46 together with the stirring paddle 42 in the stirring chamber A1, the stirring paddle 42 and the stirring sheet 46 enable stirring the toner without retaining the toner in the clearance C. The tip end side of the stirring sheet 46 is in sliding contact with the inner circumferential surface of the cartridge case 31, so that the toner adhering to the inner circumferential surface of the cartridge case 31 is scraped off by the stirring sheet 46. The upper part of the cartridge case 31 (the case cover 33) bulges upward to widen the stirring chamber A1, but the toner adhering to the bulged part is also scraped off by the stirring sheet 46. Thus, the toner in the cartridge case 31 can be used without waste.

The base end side of the stirring sheet 46 is supported by the stirring paddle 42, and the tip end side of the stirring sheet 46 is formed to be deformable. Since the base end side of the stirring sheet 46 is supported by the stirring paddle 42, the deformation of the base end side of the stirring sheet 46 due to toner resistance is suppressed. The toner is stably stirred by the stirring sheet 46, and fluttering of the stirring sheet 46 is suppressed to prevent occurrence of abnormal noise. Even if the stirring sheet 46 is formed in a film-shape, the toner adhering to the inner circumferential surface of the cartridge case 31 can be scraped off by the tip end side of the stirring sheet 46 with the deformation of the base end side of the stirring sheet 46 suppressed.

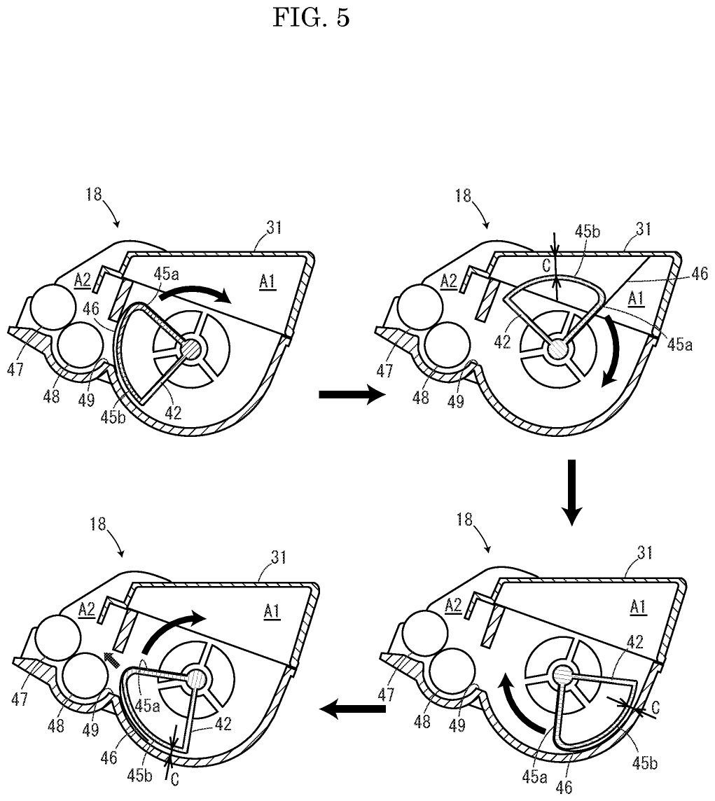

The cartridge case 31 has a developing chamber A2 adjacent to the stirring chamber A1, and the developing roller 47 and a supply roller 48 are rotatably installed in the developing chamber A2. The cartridge case 31 has a supply port communicating the stirring chamber A1 with the developing chamber A2. The toner in the stirring chamber A1 is supplied to the supply roller 48 through the supply port 49, and then is supplied from the supply roller 48 to the developing roller 47. In the developing cartridge 18 of the embodiment, when the stirring paddle 42 is positioned in a specific rotational phase, the supply port 49 is blocked by the stirring sheet 46 to suppress the toner leakage during transportation of the developing cartridge 18 (see FIG. 5).

With reference to FIG. 5, the stirring operation of the developing cartridge will be described. FIG. 5 is a transition diagram of the stirring operation of the developing cartridge of the embodiment. In FIG. 5, the toner is not shown for convenience of description.

As shown in the upper left figure of FIG. 5, the stirring paddle 42 is positioned in a specific rotational phase in the initial state (the shipping state). In this rotational phase, the arc surface 45b of the stirring paddle 42 faces the supply port 49, and the supply port 49 is blocked by the stirring sheet 46 deformed along the stirring paddle 42. The restoring force caused by the deformation of the stirring sheet 46 presses the stirring sheet 46 against the opening edge of the supply port 49 of the cartridge case 31. Since the corner between the front flat surface 45a in the rotational direction of the stirring paddle 42 and the arc surface 45b is curved, even if the stirring sheet 46 is deformed along the stirring paddle 42, it is not creased.

As shown in the upper right figure of FIG. 5, when the stirring paddle 42 is rotated in the clockwise direction by a predetermined angle from the initial state, the stirring sheet 46 is separated from the supply port 49, and the stirring chamber A1 and the developing chamber A2 are communicated with each other. Although the clearance C between the stirring paddle 42 and the cartridge case 31 is increased, the tip end side of the stirring sheet 46 comes into contact with the ceiling surface of the cartridge case 31 by the recovery of the deformed stirring sheet 46. The toner is stirred by the stirring sheet 46 and the stirring paddle 42 while the stirring sheet 46 in contact with the ceiling surface of the cartridge case 31, and the toner adhering to the ceiling surface of the cartridge case 31 is also scraped off by the stirring sheet 46.

As shown in the lower right figure of FIG. 5, when the stirring paddle 42 is further rotated in the clockwise direction by a predetermined angle, the stirring paddle 42 faces the bottom surface of the cartridge case 31. The bottom surface of the cartridge case 31 is a circumferential surface along the arc surface 45b of the stirring paddle 42, and the clearance C between the stirring paddle 42 and the cartridge case 31 becomes narrow. The stirring sheet 46 is pressed against the bottom surface of the cartridge case 31 and deformed, and the stirring sheet 46 enters the clearance C between the stirring paddle 42 and the cartridge case 31. The stirring sheet 46 comes into contact with the bottom surface of the cartridge case 31, so that the toner is stirred without remaining in the clearance C.

As shown in the lower left figure of FIG. 5, when the stirring paddle 42 is further rotated in the clockwise direction by a predetermined angle, the stirring paddle 42 is brought closer to the supply port 49 of the cartridge case 31. The toner is pushed to the supply port 49 by the front flat surface 45a in the rotational direction of the stirring paddle 42, and then supplied from the stirring chamber A1 to the developing chamber A2 through the supply port 49. At this time, since the stirring sheet 46 enters the clearance C between the stirring paddle 42 and the cartridge case 31, the toner does not enter the clearance C when pushing the toner into the supply port 49. Thus, the toner in the cartridge case 31 can be pushed out well.

As described above, according to the present embodiment, when the developing cartridge 18 is used, the toner in the stirring chamber A1 is stirred by the stirring paddle 42 and the stirring sheet 46 to suppress the uneven concentration of the toner. In addition, when the developing cartridge 18 is shipped, the stirring paddle 42 is positioned in a specific rotational phase, so that the supply port 49 is blocked by the stirring sheet 46 to suppress the toner leakage. Therefore, since the toner leakage is suppressed without separately preparing a seal member for sealing the supply port 49, the cost can be reduced.

Although the stirring paddle is formed in a fan-shape in a cross section in the present embodiment, the stirring paddle only needs to have a shape that can stir the toner. For example, the stirring paddle may be formed in a plate-shape.

In addition, although the stirring sheet is formed in a rectangular film-shape in the embodiment, the stirring sheet only needs to protrude outward in the radial direction from the rotational locus drawn by the tip end of the stirring paddle. For example, a cut or the like may be formed in the stirring sheet.

In addition, although the tip end side of the stirring sheet is in sliding contact with the inner circumferential surface of the cartridge case in the embodiment, it is not necessary that the tip end side of the stirring sheet is in sliding contact with the entire of the inner circumferential surface of the cartridge case.

In the present embodiment, the stirring sheet is attached on the front flat surface in the rotational direction of the stirring paddle, but the stirring sheet may be attached on the rear flat surface in the rotational direction of the stirring paddle.

In the present embodiment, the developing cartridge having the developing device is described as an example of the toner cartridge, but the toner cartridge and the developing device may be separately formed.

In this embodiment, the printer is shown as the image forming device, but it is not limited to this configuration. In addition to a copying machine and a facsimile machine, the image forming apparatus may be a multifunctional peripheral including a combination of printing, copying and faxing functions.

The present embodiment has been described, but as another embodiment, the above embodiment and a variation may be wholly or partially combined.

The present embodiment is described, but as another embodiment, the above embodiment and the modified examples may be wholly or partially combined.

In addition, the technology of the present disclosure is not limited to the above embodiment and may be changed, replaced or modified in various ways without departing from the purpose of the technical idea. Furthermore, if technological ideas can be realized in a different way by technological progress or a derived different technology, they may be implemented using that method. Thus, the claims cover all possible embodiments within the scope of technical thought.

1. A toner cartridge comprising:
a cartridge case in which a toner stirring chamber is formed;
a stirring paddle which is rotatably installed in the stirring chamber; and
a stirring sheet rotatable together with the stirring paddle in the stirring chamber, wherein
the cartridge case has a toner supply port,
the stirring sheet protrudes outward in a radial direction from a rotational locus drawn by a tip end of the stirring paddle, and
when the stirring paddle is positioned at a specific rotational phase, the stirring sheet blocks the supply port.

2. The toner cartridge according to claim 1, wherein
a tip end side of the stirring sheet is in sliding contact with an inner circumferential surface of the cartridge case.

3. The toner cartridge according to claim 2, wherein
a base end side of the stirring sheet is supported by the stirring paddle, and the tip end side of the stirring sheet is formed so as to be deformable.

4. The toner cartridge according to claim 1, wherein
the stirring paddle is formed to be a fan shape in a cross section.

5. The toner cartridge according to claim 4, wherein
the stirring paddle is formed to be a hollow cylindrical shape.

6. The toner cartridge according to claim 4, wherein
the stirring paddle has a front flat surface on a front side in a rotational direction, a rear flat surface on a rear side in the rotational direction, and an arc surface between the front flat surface and the rear flat surface, and
an angle between the front flat surface and the arc surface is curved, and an angle between the rear flat surface and the arc surface is bent.

7. The toner cartridge according to claim 1, wherein
the cartridge case has a developing chamber adjacent to the stirring chamber,
a developing roller and a supply roller are rotatably installed in the developing chamber, and
the stirring chamber and the developing chamber are communicated with each other through the supply port.

8. An image forming apparatus comprising the toner cartridge according to claim 1.
